(19) United States
(12) Patent Application Publication
(10) Pub. No.: US 2015/0144214 A1
(43) Pub. Date: May 28, 2015

(54) Mixed Water Control Valve for Faucet

(71) Applicant: Chia-Po Chang, Lu-Kang Township (TW)

(72) Inventor: Chia-Po Chang, Lu-Kang Township (TW)

(21) Appl. No.: 14/087,033

(22) Filed: Nov. 22, 2013

(51) Int. Cl. E03C 1/04; F16K 11/02

(52) U.S. Cl. CPC E03C 1/04; F16K 11/02
USPC 137/625.41

(57) ABSTRACT

A mixed water control valve for a faucet includes a valve housing, a valve cap mounted on the valve housing, a control bolt rotatably mounted on the valve cap and having a lower end extending into the valve housing and an upper end protruding outward from the valve cap, a base disposed in the valve housing and combined with the control bolt to rotate in concert with the control bolt, an upper ceramic plate mounted in the valve housing, a lower ceramic plate mounted in the valve housing, two water stop gaskets mounted in the valve housing, two springs mounted in the valve housing, two mounting sleeves mounted in the valve housing, and a balance unit mounted in the valve housing.

### BACKGROUND OF THE INVENTION

1. Field of the Invention

The present invention relates to a control valve and, more particularly, to a mixed water control valve with precision ceramic material.

2. Description of the Related Art

A conventional mixed water faucet comprises a water outlet and a precision ceramic control valve located above the water outlet. The water outlet has a lower portion provided with a hot water channel, a cold water channel and a water output channel. The hot water channel and the cold water channel of the water outlet are controlled and switched by the precision ceramic control valve. The precision ceramic control valve has an interior provided with a chamber. The hot water flows through the hot water channel of the water outlet into the chamber of the precision ceramic control valve, and the cold water flows through the cold water channel of the water outlet into the chamber of the precision ceramic control valve. Then, the hot water and the cold water are mixed in the chamber of the precision ceramic control valve. Then, the mixed water flows outward from the water output channel of the water outlet for use of a user. The mixture proportion of the hot water and the cold water can be regulated according to the user's requirement. However, the precision ceramic control valve cannot withstand the impact of a larger water pressure so that the water is subjected to action of the water pressure and easily passes through a narrow clearance between the precision ceramic control valve and the water outlet, thereby causing a leakage. In addition, the precision ceramic control valve directly presses the water outlet to increase the frictional resistance between the precision ceramic control valve and the water outlet, so that the precision ceramic control valve is not operated and rotated easily and conveniently.

The closest prior art reference of which the applicant is aware was disclosed in his U.S. Pat. No. 7,806,134, entitled by “MIXED WATER CONTROL VALVE HAVING WATER PRESSURE BALANCE FUNCTION TO STABILIZE WATER TEMPERATURE”.

### BRIEF SUMMARY OF THE INVENTION

The primary objective of the present invention is to provide a mixed water control valve that has a water-tight structure to prevent from incurring water leakage.

In accordance with the present invention, there is provided a mixed water control valve comprising a valve housing, a valve cap mounted on the valve housing, a control bolt rotatably mounted on the valve cap and having a lower end extending into the valve housing and an upper end protruding outward from the valve cap, a base disposed in the valve housing and combined with the control bolt to rotate in concert with the control bolt, an upper ceramic plate mounted in the valve housing, a lower ceramic plate mounted in the valve housing, two water stop gaskets mounted in the valve housing, two springs mounted in the valve housing, two mounting sleeves mounted in the valve housing, and a balance unit mounted in the valve housing. The valve housing has an interior provided with a receiving space, a water inlet seat and a chamber. The receiving space of the valve housing receives the control bolt, the base, the upper ceramic plate and the lower ceramic plate. The water inlet seat of the valve housing is located between the receiving space and the chamber and has an upper portion provided with two positioning recesses each connected to the receiving space and a lower portion provided with two water inlet channels each connected to the respective positioning recess and each connected to the chamber. The chamber of the valve housing is connected to each of the positioning recesses via each of the water inlet channels. The valve housing has at least one water outlet channel which is defined between an inner wall of the valve housing and the water inlet seat and is extended through a top face and a bottom face of the valve housing. The upper ceramic plate is located between the base and the lower ceramic plate. The upper ceramic plate has a surface provided with two conducting slots and has a top provided with at least one driven hole. The base has a bottom provided with at least one driving leg inserted into the driven hole of the upper ceramic plate. The lower ceramic plate is located between the upper ceramic plate and the water stop gaskets. The lower ceramic plate has a surface provided with two conducting holes each aligning with the respective positioning recess of the water inlet seat. The lower ceramic plate has a periphery provided with at least one fixing recess fixed in the valve housing. Each of the water stop gaskets is mounted in the respective positioning recess of the water inlet seat and is located between the lower ceramic plate and the respective spring. Each of the water stop gaskets has an interior provided with a lip. Each of the springs is mounted in the respective positioning recess of the water inlet seat and is biased between the respective water stop gasket and the water inlet seat of the valve housing to push the respective water stop gasket toward the lower ceramic plate. Each of the springs has an upper end abutting the lip of the respective water stop gasket and a lower end abutting a bottom of the respective positioning recess. The balance unit is mounted in the chamber of the valve housing. Thus, the water stop gaskets are pushed toward the lower ceramic plate by action of the springs so that the water stop gaskets press and seal a bottom of the lower ceramic plate at a normal state so as to cover the conducting holes of the lower ceramic plate, such that a water flow from the water inlet channels of the water inlet seat cannot pass through a narrow gap defined between the lower ceramic plate and the water inlet seat of the valve housing due to a strong water pressure, so as to prevent from incurring a water leakage.

According to the primary advantage of the present invention, the water stop gaskets completely and closely press and seal the bottom of the lower ceramic plate at a normal state by successive push of the springs so as to cover the conducting holes of the lower ceramic plate, so that the water flow from the water inlet channels of the water inlet seat cannot pass through the narrow gap between the lower ceramic plate and the water inlet seat of the valve housing due to a strong water pressure, thereby preventing from incurring a water leakage.

According to another advantage of the present invention, the water stop gaskets and the springs separate the upper ceramic plate and the lower ceramic plate from the water inlet seat of the valve housing to prevent the upper ceramic plate and the lower ceramic plate from directly pressing the water inlet seat of the valve housing so as to reduce the friction resistance so that the upper ceramic plate is moved relative to the lower ceramic plate easily and conveniently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a mixed water control valve for a faucet in accordance with the preferred embodiment of the present invention.

FIG. 2 is an exploded perspective view of the mixed water control valve for a faucet as shown in FIG. 1.

FIG. 3 is a front cross-sectional view of the mixed water control valve for a faucet as shown in FIG. 1.

FIG. 4 is a schematic operational view of the mixed water control valve for a faucet as shown in FIG. 3 in use.

FIG. 5 is a schematic operational view of the mixed water control valve for a faucet as shown in FIG. 1 in use.

### DETAILED DESCRIPTION OF THE INVENTION

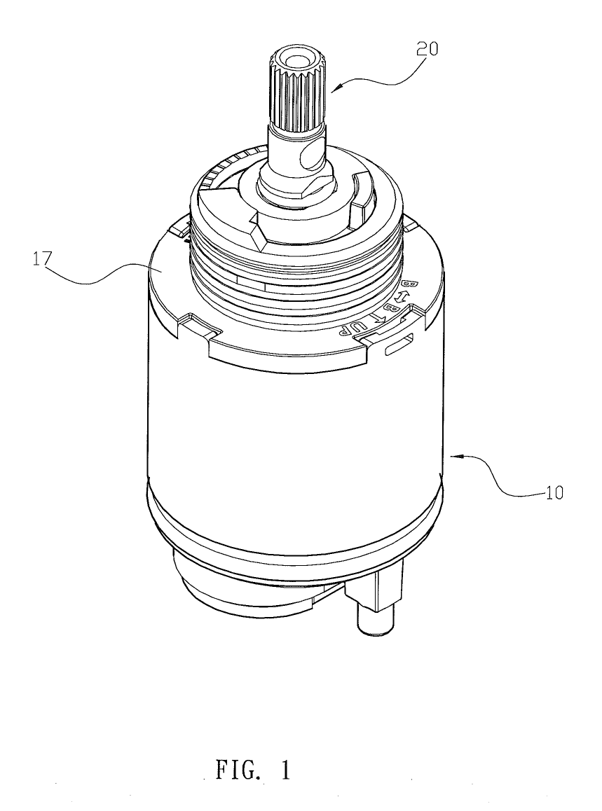

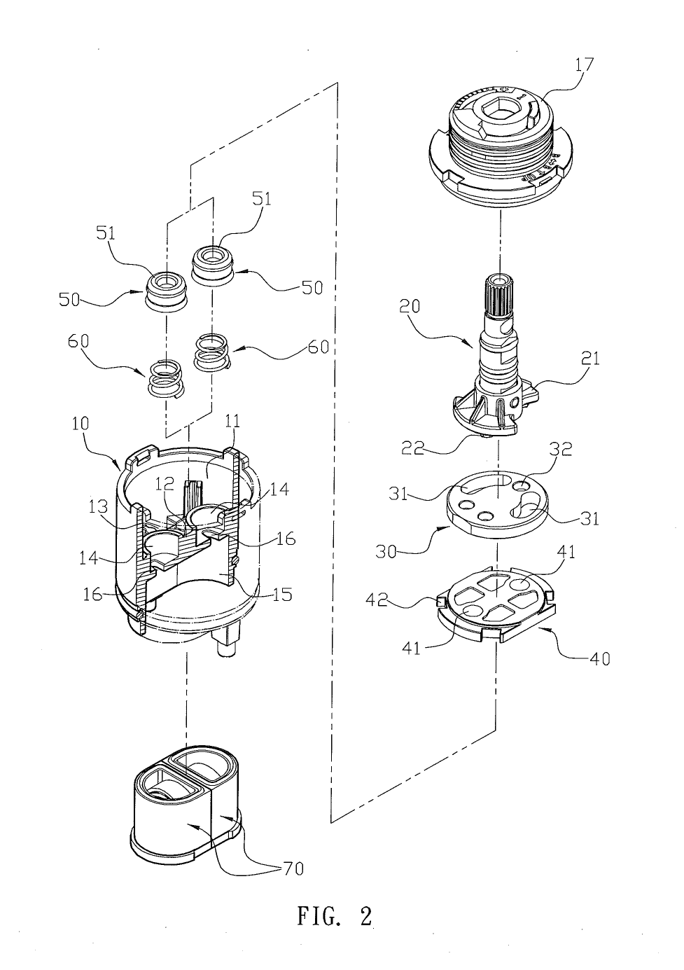

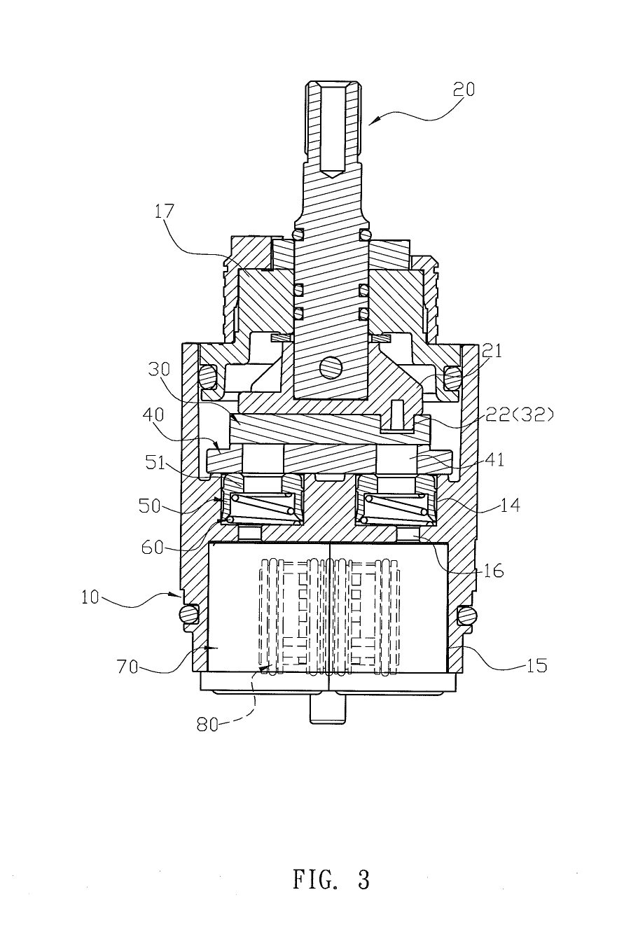

Referring to the drawings and initially to FIGS. 1-3, a mixed water control valve for a faucet in accordance with the preferred embodiment of the present invention comprises a valve housing 10, a valve cap 17 mounted on the valve housing 10, a control bolt 20 rotatably mounted on the valve cap 17 and having a lower end extending into the valve housing 10 and an upper end protruding outward from the valve cap 17, a base 21 disposed in the valve housing 10 and combined with the control bolt 20 to rotate in concert with the control bolt 20, an upper ceramic plate 30 mounted in the valve housing 10, a lower ceramic plate 40 mounted in the valve housing 10, two water stop gaskets 50 mounted in the valve housing 10, two springs 60 mounted in the valve housing 10, two mounting sleeves 70 mounted in the valve housing 10, and a balance unit 80 mounted in the valve housing 10.

The valve housing 10 has an interior provided with a receiving space 11, a water inlet seat 12 and a chamber 15. The receiving space 11 of the valve housing 10 receives the control bolt 20, the base 21, the upper ceramic plate 30 and the lower ceramic plate 40. The water inlet seat 12 of the valve housing 10 is under the receiving space 11 and above the chamber 15. The water inlet seat 12 of the valve housing 10 is located between the receiving space 11 and the chamber 15 and has an upper portion provided with two positioning recesses 14 each connected to the receiving space 11 and a lower portion provided with two water inlet channels 16 each connected to the respective positioning recess 14 and each connected to the chamber 15. The chamber 15 of the valve housing 10 is under the water inlet seat 12 and is connected to each of the positioning recesses 14 via each of the water inlet channels 16. The valve housing 10 has at least one water outlet channel 13 which is defined between an inner wall of the valve housing 10 and the water inlet seat 12 and is extended through a top face and a bottom face of the valve housing 10.

The upper ceramic plate 30 is above the lower ceramic plate 40 and is located between the base 21 and the lower ceramic plate 40. The upper ceramic plate 30 has a surface provided with two conducting slots 31 and has a top provided with at least one driven hole 32. Each of the conducting slots 31 of the upper ceramic plate 30 has a substantially arcuate shape.

The base 21 is combined with the bottom of the control bolt 20 and is above the upper ceramic plate 30. The base 21 has a bottom provided with at least one driving leg 22 inserted into the driven hole 32 of the upper ceramic plate 30, so that the upper ceramic plate 30 is rotatable in concert with the base 21.

The lower ceramic plate 40 is above the water stop gaskets 50 and is located between the upper ceramic plate 30 and the water stop gaskets 50. The lower ceramic plate 40 has a surface provided with two conducting holes 41 each aligning with the respective positioning recess 14 of the water inlet seat 12. The lower ceramic plate 40 has a periphery provided with at least one fixing recess 42 fixed in the valve housing 10.

The water stop gaskets 50 are above the springs 60. Each of the water stop gaskets 50 is mounted in the respective positioning recess 14 of the water inlet seat 12 and is located between the lower ceramic plate 40 and the respective spring 60. Each of the water stop gaskets 50 has an interior provided with a lip 51.

Each of the springs 60 is mounted in the respective positioning recess 14 of the water inlet seat 12 and is biased between the respective water stop gasket 50 and the water inlet seat 12 of the valve housing 10 to push the respective water stop gasket 50 toward the lower ceramic plate 40. Each of the springs 60 has an upper end abutting the lip 51 of the respective water stop gasket 50 and a lower end abutting a bottom of the respective positioning recess 14.

Thus, the water stop gaskets 50 are pushed toward the lower ceramic plate 40 by action of the springs 60 so that the water stop gaskets 50 press and seal a bottom of the lower ceramic plate 40 at a normal state so as to cover the conducting holes 41 of the lower ceramic plate 40, such that a water flow from the water inlet channels 16 of the water inlet seat 12 cannot pass through a narrow gap defined between the lower ceramic plate 40 and the water inlet seat 12 of the valve housing 10 due to a strong water pressure, so as to prevent from incurring a water leakage.

The mounting sleeves 70 are juxtaposed to each other and are mounted in the chamber 15 of the valve housing 10. Each of the mounting sleeves 70 is connected to the respective water inlet channel 16 of the water inlet seat 12. The balance unit 80 is mounted in the chamber 15 of the valve housing 10.

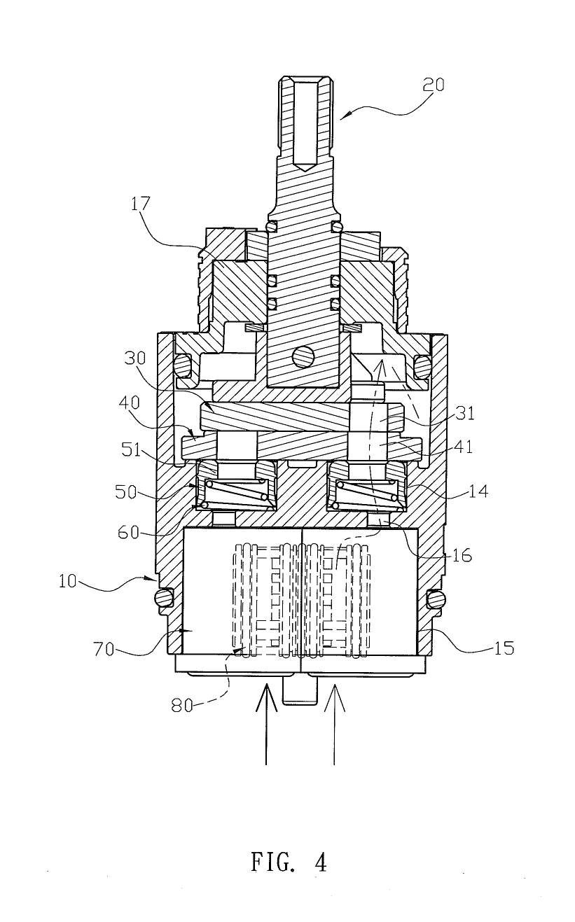

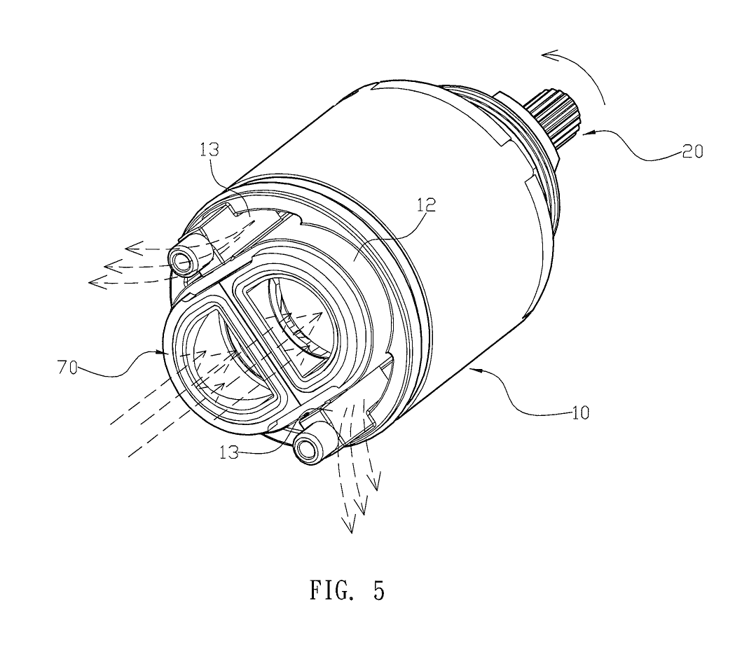

In operation, referring to FIGS. 4 and 5 with reference to FIGS. 1-3, when the control bolt 20 is rotated, the base 21 is driven by the control bolt 20 to rotate the upper ceramic plate 30 so that the upper ceramic plate 30 is rotated relative to the lower ceramic plate 40, and each of the conducting slots 31 of the upper ceramic plate 30 is moved relative to the respective conducting hole 41 of the lower ceramic plate 40 to conduct or interrupt the respective conducting hole 41 of the lower ceramic plate 40, so as to regulate the water flow passing through the respective conducting hole 41 of the lower ceramic plate 40. When in use, cold water and hot water are introduced through the mounting sleeves 70 into the chamber 15 of the valve housing 10. At this time, the balance unit 80 balances and stabilize the water pressure. Then, the cold water and the hot water in turn flow through the water inlet channels 16 of the water inlet seat 12, the water stop gaskets 50, the conducting holes 41 of the lower ceramic plate 40 and the conducting slots 31 of the upper ceramic plate 30 into the receiving space 11 of the valve housing 10 and are mixed in the receiving space 11 of the valve housing 10. Then, the mixed water flows outward from the water outlet channel 13 of the valve housing 10 for a user's usage.

Accordingly, the water stop gaskets 50 completely and closely press and seal the bottom of the lower ceramic plate 40 at a normal state by successive push of the springs 60 so as to cover the conducting holes 41 of the lower ceramic plate 40, so that the water flow from the water inlet channels 16 of the water inlet seat 12 cannot pass through the narrow gap between the lower ceramic plate 40 and the water inlet seat 12 of the valve housing 10 due to a strong water pressure, thereby preventing from incurring a water leakage. In addition, the water stop gaskets 50 and the springs 60 separate the upper ceramic plate 30 and the lower ceramic plate 40 from the water inlet seat 12 of the valve housing 10 to prevent the upper ceramic plate 30 and the lower ceramic plate 40 from directly pressing the water inlet seat 12 of the valve housing 10 so as to reduce the friction resistance so that the upper ceramic plate 30 is moved relative to the lower ceramic plate 40 easily and conveniently.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A mixed water control valve comprising:
a valve housing;
a valve cap mounted on the valve housing;
a control bolt rotatably mounted on the valve cap and having a lower end extending into the valve housing and an upper end protruding outward from the valve cap;
a base disposed in the valve housing and combined with the control bolt to rotate in concert with the control bolt;
an upper ceramic plate mounted in the valve housing;
a lower ceramic plate mounted in the valve housing;
two water stop gaskets mounted in the valve housing;
two springs mounted in the valve housing;
two mounting sleeves mounted in the valve housing; and
a balance unit mounted in the valve housing; wherein:
the valve housing has an interior provided with a receiving space, a water inlet seat and a chamber;
the receiving space of the valve housing receives the control bolt, the base, the upper ceramic plate and the lower ceramic plate;
the water inlet seat of the valve housing is located between the receiving space and the chamber and has an upper portion provided with two positioning recesses each connected to the receiving space and a lower portion provided with two water inlet channels each connected to the respective positioning recess and each connected to the chamber;
the chamber of the valve housing is connected to each of the positioning recesses via each of the water inlet channels;
the valve housing has at least one water outlet channel which is defined between an inner wall of the valve housing and the water inlet seat and is extended through a top face and a bottom face of the valve housing;
the upper ceramic plate is located between the base and the lower ceramic plate;
the upper ceramic plate has a surface provided with two conducting slots and has a top provided with at least one driven hole;
the base has a bottom provided with at least one driving leg inserted into the driven hole of the upper ceramic plate;
the lower ceramic plate is located between the upper ceramic plate and the water stop gaskets;
the lower ceramic plate has a surface provided with two conducting holes each aligning with the respective positioning recess of the water inlet seat;
the lower ceramic plate has a periphery provided with at least one fixing recess fixed in the valve housing;
each of the water stop gaskets is mounted in the respective positioning recess of the water inlet seat and is located between the lower ceramic plate and the respective spring;
each of the water stop gaskets has an interior provided with a lip;
each of the springs is mounted in the respective positioning recess of the water inlet seat and is biased between the respective water stop gasket and the water inlet seat of the valve housing to push the respective water stop gasket toward the lower ceramic plate;
each of the springs has an upper end abutting the lip of the respective water stop gasket and a lower end abutting a bottom of the respective positioning recess;
the balance unit is mounted in the chamber of the valve housing;
the water stop gaskets are pushed toward the lower ceramic plate by action of the springs so that the water stop gaskets press and seal a bottom of the lower ceramic plate at a normal state so as to cover the conducting holes of the lower ceramic plate, such that a water flow from the water inlet channels of the water inlet seat cannot pass through a narrow gap defined between the lower ceramic plate and the water inlet seat of the valve housing due to a strong water pressure, so as to prevent from incurring a water leakage.

2. The mixed water control valve of claim 1, wherein each of the conducting slots of the upper ceramic plate has a substantially arcuate shape.
